(19) United States
(12) Patent Application Publication
(10) Pub. No.: US 2018/0284312 A1
(43) Pub. Date: Oct. 4, 2018

(54) T1 DISTRIBUTION-BASED LOGGING SYSTEMS AND METHODS USING BLIND SOURCE SEPARATION INDEPENDENT COMPONENT ANALYSIS

(71) Applicant: Halliburton Energy Services, Inc., Houston, TX (US)

(72) Inventor: Pedro Antonio Romero, Maturin (VE)

(21) Appl. No.: 15/754,815

(22) PCT Filed: Oct. 19, 2015
(86) PCT No.: PCT/US2015/056171

§ 371 Date: Feb. 23, 2018

(51) Int. Cl. G01V 3/32; E21B 47/00

(52) U.S. Cl. CPC G01V 3/32; G01N 24/081; E21B 47/00

(57) ABSTRACT

A method of generating a data log includes receiving formation response signals with a nuclear magnetic resonance (NMR) tool. The method further includes processing the formation response signals to obtain a T1 distribution of nuclei of a mixture in the formation and performing a blind source separation (BSS) independent component analysis (ICA) on the T1 distribution. The method further includes obtaining mixing data, comprising ratios of components of the mixture, from the BSS ICA and generating a data log comprising the mixing data.

### BACKGROUND

In the oil and gas industry, measurement of nuclear magnetic resonance (NMR) properties of a subterranean formation is common. NMR concepts are based upon the fact that the nuclei of many elements (and in particular, hydrogen) have angular momentum (spin) and a magnetic moment. The nuclei have a characteristic frequency of oscillation, known as the Larmor frequency, which is related to the magnitude of the magnetic field in their locality.

There are two phases to NMR measurement: polarization and acquisition. First, the nuclear spins of nuclei in the exploration region are brought into alignment, i.e. polarized, by introducing a static magnetic field, resulting in a net magnetization. The nuclear polarization takes a characteristic time, T1, to achieve equilibrium. Second, the equilibrium state is disrupted, i.e. tipped, by a pulse from an oscillating magnetic field. After tipping, the spins “precess” around the static field at the Larmor frequency. Precession is a change in the orientation of the rotational axis of a rotating body, here the nuclei. However, due to such factors as inhomogeneity in the static field, imperfect instrumentation, or microscopic material inhomogeneities, each nuclear spin precesses at a slightly different rate than the others. Thus, after time, the spins will no longer be precessing in phase with one another. This “dephasing” can be accounted for using known techniques, e.g., generating spin “echoes” by applying a series of pulses to repeatedly refocus the spin system.

Considering a detailed example, an initial electromagnetic (typically radio frequency) pulse is applied long enough to “tip” the nuclei in a mixture into a plane perpendicular to the static magnetic field. The nuclei precess in unison, producing a large signal in the antenna, but then quickly dephase due to inhomogeneities. Another pulse is applied to reverse their direction of precession, which causes the spins to come back in phase again after a short time. Being in phase, the nuclei produce another strong signal called an echo. The spins quickly dephase, but can be rephased by another pulse. The echo magnitude decreases with time, and one measurement typically includes many hundreds of echoes, i.e. an echo train, where the time between each echo is of the order of 1 millisecond or less. The decay time, T2, of the echo amplitude correlates in predictable ways to the materials in the mixture. As such, T2 has been used to identify materials in a mixture of unknown materials. However, T2 and T1 are properties of different physical processes despite having similar names, and identification of components in a mixture based on T2 measurements is complex and expensive.

### BRIEF DESCRIPTION OF THE DRAWINGS

Accordingly, there are disclosed herein various blind source separation (BSS) independent component analysis (ICA) systems and methods using T1 distributions. In the following detailed description of the various disclosed embodiments, reference will be made to the accompanying drawings in which:

FIG. 1 is a contextual view of an illustrative logging while drilling environment;

FIG. 2 is a contextual view of an illustrative wireline tool environment;

FIG. 3A is a graphical view of illustrative T1 distributions as inputs to and outputs from the BSS ICA;

FIG. 3B is a graphical view of illustrative T1 distributions output from the BSS ICA compared to reference T1 distributions;

FIG. 4 is a table of illustrative mixing ratios of independent components of a formation mixture;

FIG. 5 is a flow diagram of an illustrative method of generating a data log based on T1 distributions; and

FIG. 6 shows several illustrative logs depicting T1 distributions and ICA results.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### NOTATION AND NOMENCLATURE

Certain terms are used throughout the following description and claims to refer to particular system components and configurations. As one of ordinary skill will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or a direct electrical or physical connection. Thus, if a first device couples to a second device, that connection may be through a direct electrical connection, through an indirect electrical connection via other devices and connections, through a direct physical connection, or through an indirect physical connection via other devices and connections in various embodiments.

### DETAILED DESCRIPTION

The issues identified in the background are at least partly addressed by systems and methods for blind source separation (BSS) independent component analysis (ICA) using T1 distributions collected by nuclear magnetic resonance (NMR) logging. Using T1 distributions, rather than T2 distributions, to identify components of a mixture such as water and hydrocarbons is simpler and cheaper because no magnetic gradient information need be accounted for. Such identification leads to an effective use of resources in the exploration context. Specifically, not only may the presence of hydrocarbons in a formation be confirmed, but the total and relative amounts of different hydrocarbons that make up a mixture from the formation may be obtained. By using this data to form a more accurate model of the formation, better decisions regarding production feasibility and estimation will result.

To illustrate a context for the disclosed systems and methods, FIG. 1 shows a well during drilling operations. Although the examples used herein discuss analyzing a downhole mixture, the methods may be performed in a laboratory environment with a sample mixture extracted from a formation.

A drilling platform 2 is equipped with a derrick 4 that supports a hoist 6. Drilling of oil and gas wells is carried out by a string of drill pipes connected together by “tool” joints 7 so as to form a drill string 8. The hoist 6 suspends a kelly 10 that lowers the drill string 8 through rotary table 12. Connected to the lower end of the drill string 8 is a drill bit 14. The bit 14 is rotated and drilling is accomplished by rotating the drill string 8, by use of a downhole motor near the drill bit, or by both methods.

Drilling fluid, termed mud, is pumped by mud recirculation equipment 16 through a supply pipe 18, through the drilling kelly 10, and down through the drill string 8 at high pressures and volumes to emerge through nozzles or jets in the drill bit 14. The mud then travels back up the hole via the annulus formed between the exterior of the drill string 8 and the borehole wall 20, through a blowout preventer, and into a mud pit 24 on the surface. On the surface, the drilling mud is cleaned and then recirculated by the recirculation equipment 16.

For a logging while drilling (LWD) environment, downhole sensors 26 are located in the drillstring 8 near the drill bit 14. The sensors 26 may include directional instrumentation and a modular resistivity tool with tilted antennas. The directional instrumentation measures the inclination angle, the horizontal angle, and the azimuthal angle (also known as the rotational or “tool face” angle) of the LWD tools. Additionally, a three axis magnetometer measures the earth's magnetic field vector. From combined magnetometer and accelerometer data, the horizontal angle of the LWD tool can be determined. In addition, a gyroscope or other form of inertial sensor may be incorporated to perform position measurements and further refine the orientation measurements.

In some embodiments, downhole sensors 26 are coupled to a telemetry transmitter that transmits telemetry signals by modulating the mud flow in drill string 8. A NMR tool 28 is included in the drillstring 8 for NMR logging purposes, including collection of T1 data, as discussed below. In another embodiment, the downhole sensors 26 include NMR sensors. A telemetry receiver 30 is coupled to the kelly 10 to receive transmitted telemetry signals. Other telemetry transmission techniques may also be used. The receiver 30 communicates the telemetry to an acquisition module 36 coupled to a data processing system 50.

The data processing system 50 includes internal data storage and memory having software (represented by removable information storage media 52), along with one or more processor cores that execute the software. The software configures the system to interact with a user via one or more input/output devices (such as keyboard 54 and display 56). Among other things, system 50 processes data received from acquisition module 36 and generates a representative display for the driller to perceive.

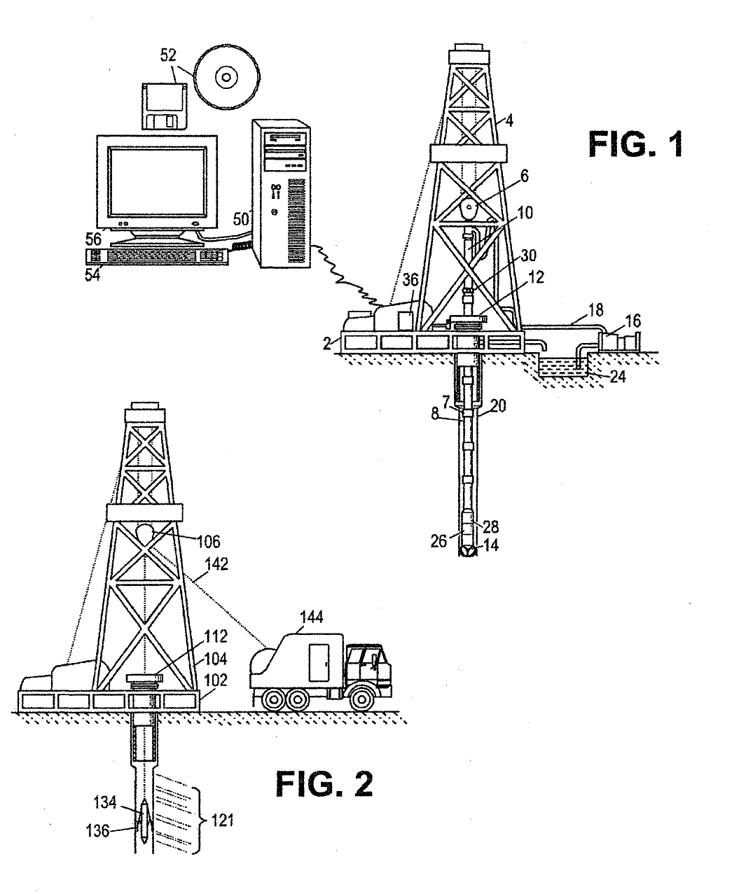

For a wireline environment, as shown in FIG. 2, a drilling platform 102 is equipped with a derrick 104 that supports a hoist 106. At various times during the drilling process, the drill string is removed from the borehole. Once the drill string has been removed, logging operations can be conducted using a wireline logging tool 134, i.e. a sensing instrument sonde suspended by a cable 142, run through the rotary table 112, having conductors for transporting power to the tool and telemetry from the tool to the surface. A multi-component induction logging portion of the logging tool 134 may have centralizing arms 136 that center the tool within the borehole as the tool is pulled uphole. A logging facility 144 collects measurements from the logging tool 134, and includes a processing system for processing and storing the measurements 121 gathered by the logging tool from the formation. In at least one embodiment, the logging tool 134 includes NMR sensors for NMR logging purposes, including collection of T1 data. In another embodiment, a separate NMR tool is run downhole using the wireline to perform the logging.

NMR logging measures the induced magnetic moment of hydrogen nuclei contained within the fluid-filled pore space of porous media such as reservoir rocks by sending signals into the formation and receiving and recording formation responses. NMR tools measuring T1 may omit a magnetic gradient sensor as magnetic gradient information need not be collected for T1 measurements. Unlike other logging measurements, e.g. resistivity measurements, NMR logging measurements respond to the presence of hydrogen protons. Because these protons primarily occur in pore fluids, NMR effectively responds to the volume, composition, viscosity, and distribution of these fluids, which may include oil, gas, and water.

NMR logs such as those shown in FIG. 6 provide information about the quantities of fluids present, the properties of these fluids, and the sizes of the pores containing these fluids. From a T1 distribution 602, it is possible to infer or estimate the volume (porosity) 604 and distribution (permeability) of the rock pore space, rock composition, type and quantity of fluid hydrocarbons, and production capabilities. Additionally, as disclosed herein, the NMR logs also include identification of components 606 of the fluids, including numerical and graphical data indicating the amounts in which the components appear, based on T1 distributions. Logs including such data are valuable for modeling formations, estimating production, and positioning equipment within the borehole. Generation of such logs may be facilitated by a BSS ICA.

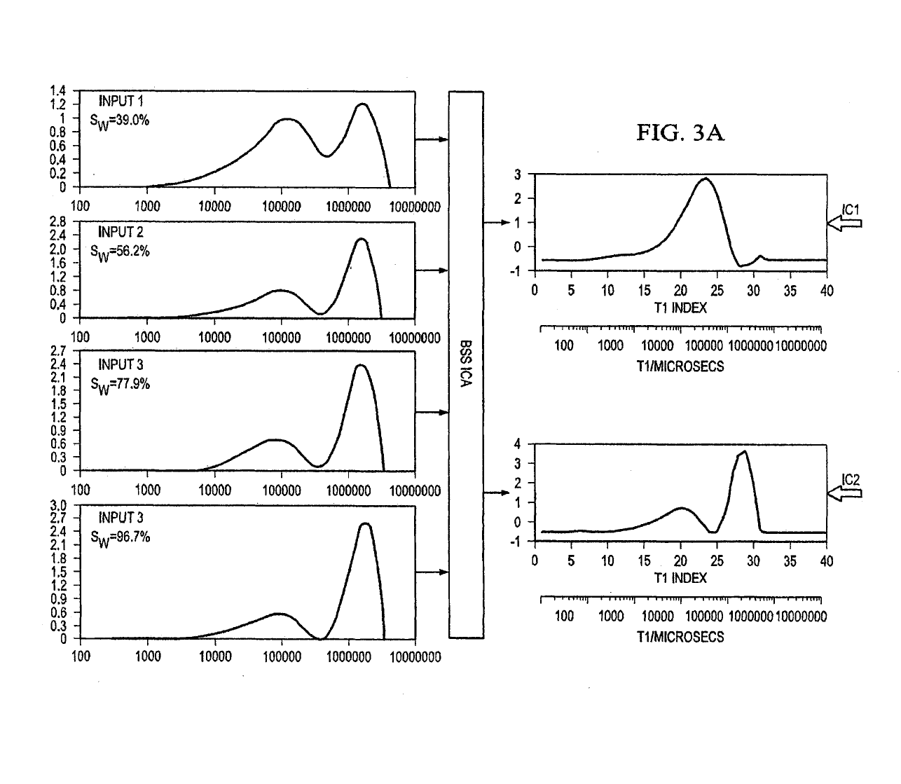

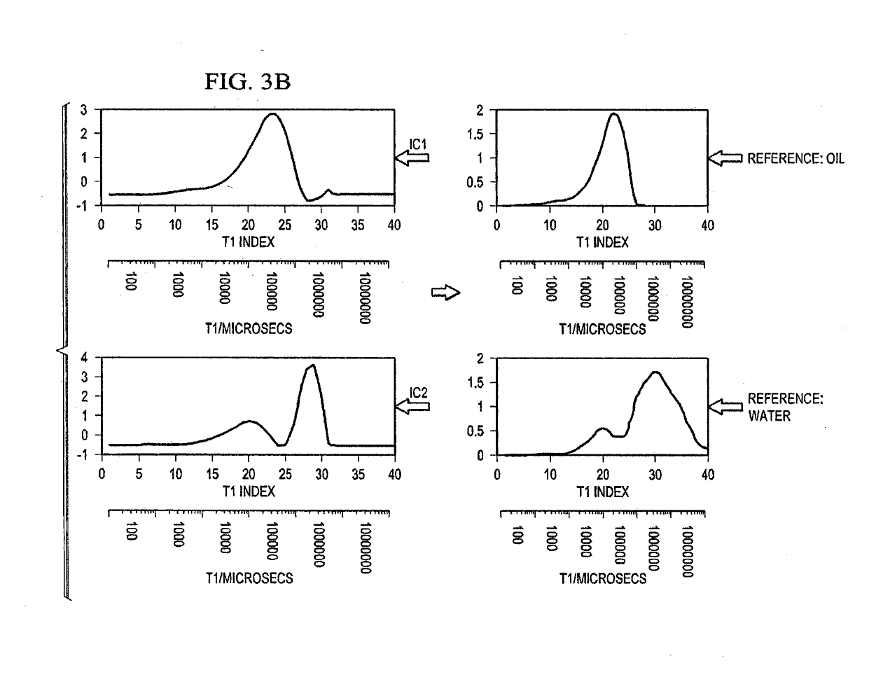

FIG. 3A is a graphical view of illustrative T1 distributions as inputs to and outputs from the BSS ICA. The BSS ICA accepts as inputs T1 distributions of a formation mixture at various points of saturation. Specifically, water or another saturation material is delivered to the formation mixture, and T1 measurements are collected and recorded as described above leading to many distribution curves that change over the course of saturation. Next, a number of T1 distribution curves are selected, here four are selected, as inputs to the BSS ICA. In at least one embodiment selection of the distribution curves can be performed by 1) initially selecting as many potential independent components as the number of depth levels from which the T1 measurements are taken; 2) performing principle component analysis on the potential independent components to determine the eigenvalues of the covariance matrix present in the data; and 3) select a number of distribution curves as inputs to the BSS ICA that will cover a majority, most, or nearly all of the cumulative signal power present in the data based on the eigenvalues.

Next, a BSS ICA model is generated that includes a plurality n of linear mixtures [x₁, x₂, . . . xₙ], resulting from a corresponding plurality n of independent source components [s₁, s₂, . . . sₙ], where

$${x}_{j} = {a}_{j 1} {s}_{1} + {a}_{j 2} {s}_{2} + … + {a}_{jn} {s}_{n} = {\sum }_{k = 1}^{n} {a}_{jk} {s}_{k}$$

and [x₁, x₂, . . . xₙ] and [s₁, s₂, sₙ] are considered random. The values of the signals are considered samples (instantiations) of the random variables, not functions of time. Expressed in vector matrix notation, the observable variable vector x is expressed as

$$x = {[ {x}_{1} , {x}_{2} , … , {x}_{n} ]}^{T} = [ \begin{matrix}{x}_{1} \\ {x}_{2} \\ ⋮ \\ {x}_{n}\end{matrix} ]$$

and the source variable vector s is expressed as

$$s = {[ {s}_{1} , {s}_{2} , … , {s}_{n} ]}^{T} = [ \begin{matrix}{s}_{1} \\ {s}_{2} \\ ⋮ \\ {s}_{n}\end{matrix} ]$$

The mixing matrix A, which encodes the estimation of the fluid saturation, is

$$\begin{matrix}A = ( {a}_{ij} \vert i = 1 , n ; j = 1 , n ) \\ = ( {a}_{j} \vert j = 1 , n ) \\ = [ \begin{matrix}{a}_{11} & … & {a}_{1 j} & … & {a}_{1 n} \\ ⋮ & & ⋮ & & ⋮ \\ {a}_{i 1} & … & {a}_{ij} & … & {a}_{in} \\ ⋮ & & ⋮ & & ⋮ \\ {a}_{n 1} & … & {a}_{nj} & … & {a}_{nn}\end{matrix} ]\end{matrix}$$

The linear mixing equation, i.e. the independent component analysis (ICA) model, is reduced to:

x=A*s

Denoting by aⱼ, the jth column of matrix A the model thus becomes:

$$x = {\sum }_{i = 1}^{n} {a}_{i} {s}_{i}$$

The measured data x may be reconstructed by performing the above calculation individually for each source sᵢ. The fluid saturation at any depth level may be obtained by integrating the area of each spectrum xᵢ=aᵢ·sᵢ at its corresponding depth level (or sequence). The ICA model is a generative model in that it describes how the observed data are generated by mixing the components s₁. The independent components are latent variables; they are not directly observable. The term “blind” in BSS reflects the fact that very little, if anything, is known in the mixing matrix A, and few assumptions are made with respect to the source signals. Specifically, the basic assumption is that the source components are statistically independent, and hence have unknown distributions as non-Gaussian as possible, to optimize a certain contrast function. The best W is found, where W is the unmixing matrix that gives

y=Wx

which is the best estimate of the independent source vector.

If the unknown mixing matrix A is square and non-singular, then

W=A⁻¹ and s=y

Otherwise, the best unmixing matrix that separates the sources is given by the generalized inverse Penrose-Moore matrix

W=A⁺ and ∥s−y∥s=min

The independent source vectors are the T1 distributions of each independent component, here independent component 1 (IC1) and independent component 2 (IC2). These independent component distributions are output for display to a human interpreter, or the independent component distributions are obtained by a processor for a non-human interpreter, e.g. analyzing the distributions using software.

FIG. 3B is a graphical view of illustrative T1 distributions output from the BSS ICA compared to reference T1 distributions, and such comparisons may be made by the interpreter as discussed above. Specifically, the IC1 and IC2 distribution are each compared to a multiple reference distributions from a database of reference distributions. The database of distributions includes T1 distributions from multiple materials (including oil, gas, and water) in multiple contexts (including the materials within porous media, not within porous media, and the like). The interpreter may identify distributions in the database that include at least one feature that is correlative to the independent component distributions or, conversely, the interpreter may identify at least one feature in an independent component distribution that is correlative to a distribution in the database. Based on the strength of the correlation, the interpreter may identify the independent component as the material from which the reference distribution was created. For example, the distribution for IC1 includes a bell-shaped peak centered at 200,000 microseconds as the dominant feature. A similar feature may be found in the reference distribution for oil not in a porous medium. As such, IC1 may be identified as oil with high confidence. In this way, dominant and even non-dominant features may be used to identify materials.

Similarly, the distribution for IC2 includes two peaks, the smaller peak preceding the larger peak, as the dominant feature. A similar feature may be found in the reference distribution for water. As such, IC2 is identified as water.

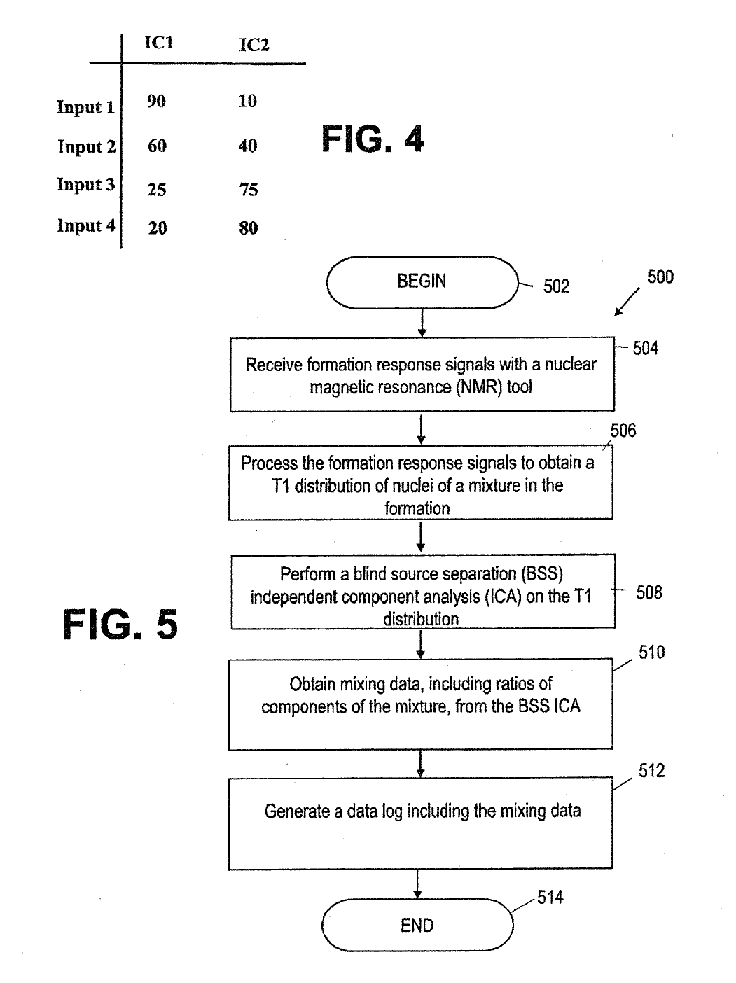

Additionally, saturation ratios and mixing data may be determined. Specifically, the saturation ratios of the inputs, the ratio of water to formation mixture, may be calculated based on the BSS ICA. The saturation ratios may be calculated using the equation x=A·s or x=Σ_{i,j=1}ⁿ aᵢⱼs̅ᵢ̅, where the vector s̅ᵢ̅ is normalized by s̅ᵢ̅=sᵢ/kᵢ, and where kᵢ equals the sum of the components of sᵢ. The contribution of any sᵢ to x at any depth level n (sᵢ is the saturation at xₙ) is given by aᵢₙ or aᵢₙ/kᵢ. The calculated saturations are the fractional weights of each component in the mixed signal x, which is measured by the tool at different depth level. In general, the saturations of these fluids sum up to 1 or 100%, but may be less, e.g., when carbon dioxide is present. For example, input 1 has a saturation ratio of 39%, input 2 has a saturation ratio of 56%, input 3 has a saturation ratio of 77%, and input 4 has a saturation ratio of 86%. The ratios of independent components within the mixture, called mixing data, at different saturations may also be determined based on the BSS ICA. FIG. 4 is a table of illustrative mixing ratios of a formation mixture at different saturation points. For example, input 1 includes 90% oil (IC1) and 10% water (IC2), input 2 includes 60% oil and 40% water, input 3 includes 25% oil and 75% water, while input 4 includes 20% oil and 80% water. These saturation ratios and mixing data may be included in the NMR log in graphical form, table form, and the like.

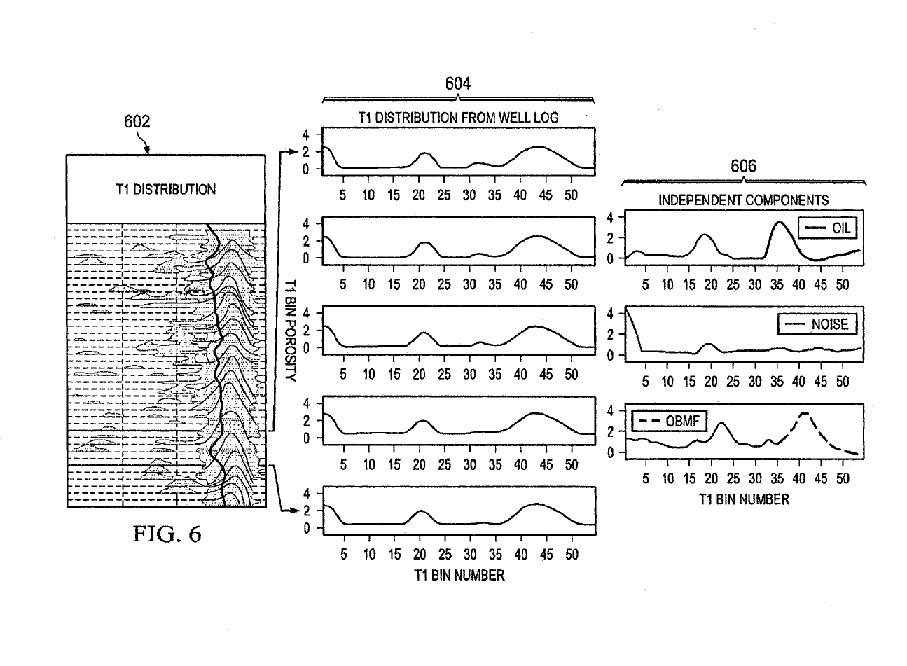

FIG. 5 is a flow diagram of an illustrative method 500 of generating a data log based on T1 distributions beginning at 502 and ending at 514. At 504, formation response signals are received by a NMR tool. As discussed above, NMR logging includes measuring induced magnetic moment of hydrogen nuclei contained within the fluid-filled pore space of porous media such as reservoir rocks by sending signals into the formation and receiving and recording formation responses. The NMR logging may be performed in a LWD or wireline embodiment, and the NMR tool may omit a magnetic gradient sensor because magnetic gradient information is not needed to collect T1 measurements.

At 506, the formation response signals are processed to obtain a T1 distribution of nuclei of a mixture in the formation. Obtaining the T1 distribution may include saturating the mixture with water, or another saturation liquid, and obtaining multiple T1 distributions over different saturation ratios. For example, water may be delivered to the formation over a period of time, and the NMR logging tool may be activated at predetermined intervals throughout the saturation. Multiple T1 distributions may be obtained, and a subset may be selected for input to the blind source separation (BSS) independent component analysis (ICA). For example, fluids with similar characteristics may be included in the same depth window for analysis.

At 508, a BSS ICA is performed on the T1 distributions. As discussed above, a BSS ICA model includes a plurality n of linear mixtures [x₁, x₂, . . . xₙ], resulting from a corresponding plurality n of independent source components [s₁, s₂, . . . sₙ], where

$${x}_{j} = {a}_{j 1} {s}_{1} + {a}_{j 2} {s}_{2} + … + {a}_{jn} {s}_{n} = {\sum }_{k = 1}^{n} {a}_{jk} {s}_{k}$$

and [x₁, x₂, . . . xₙ] and [s₁, s₂, sₙ] are considered random, not proper time signals. A mixing matrix and unmixing matrix provide the basis for separating the components of the mixture into their own T1 distributions. From the independent distributions, the components may be identified based on features that are correlative to reference distributions. For example, the features may be correlative to reference T1 distributions of hydrocarbons, such as oil and gas, or water. Such identification may occur by a human interpreter or a software interpreter and may be based on both dominant and non-dominant features of the distributions. The reference distributions may be compiled in a database for easy accessibility.

At 510, mixing data is obtained from the BSS ICA. The mixing data may include the ratio of independent components in the mixture at each stage of saturation or along various positions of the borehole. Saturation ratios, including the ratio of the saturation element to the mixture, may also be obtained for each input. At 512, a data log is generated comprising the mixing data. The saturation ratios may also be included in the log. The method may also include displaying the mixing data in graphical or table form as part of the log or separately from the log.

In at least one embodiment, a method of generating a data log includes receiving formation response signals with a nuclear magnetic resonance (NMR) tool. The method further includes processing the formation response signals to obtain a T1 distribution of nuclei of a mixture in the formation. The method further includes performing a blind source separation (BSS) independent component analysis (ICA) on the T1 distribution. The method further includes obtaining mixing data, comprising ratios of components of the mixture, from the BSS ICA. The method further includes generating a data log comprising the mixing data.

In another embodiment, a system for generating a subsurface data log includes a nuclear magnetic resonance (NMR) tool that receives formation response signals. The system also includes a processor and memory. The processor processes the formation response signals to obtain a T1 distribution of nuclei of a mixture in the formation, performs a blind source separation (BSS) independent component analysis (ICA) on the T1 distribution, obtains mixing data, comprising ratios of components of the mixture, from the BSS ICA, and generates a data log comprising the mixing data. The memory stores the data log.

The following features may be incorporated into the various embodiments. The T1 distribution may be obtained without magnetic gradient information. Generating the data log may include identifying the ratios of components as a function of position along a borehole. Performing the BSS ICA may include identifying a component of the mixture from a spectral distribution curve. Identifying the component may include observing at least one feature of the spectral distribution curve that is correlative to the component. The at least one feature may be correlative to hydrocarbons. The at least one feature may be correlative to water. Obtaining the T1 distribution may include saturating the mixture with water and obtaining multiple T1 distributions over different saturation ratios. The method may include displaying the mixing data. The NMR tool may omit a magnetic gradient sensor. The processor may reside in the NMR tool. The processor may reside in a data processing system on the surface of the formation. The system may include a display that shows the mixing data. Performing the BSS ICA may cause the processor to output to the display a spectral distribution curve of one component of the mixture such that an interpreter may identify and input the component based on at least one feature of the spectral distribution curve that is correlative to the component. The feature may be correlative to hydrocarbons. The feature may be correlative to water. Generating the data log may cause the processor to identify the ratios of components as a function of position along a borehole. Obtaining the T1 distribution may cause the processor to obtain multiple T1 distributions over different saturation ratios. The system may include a display that shows the mixing data.

While the present disclosure has been described with respect to a limited number of embodiments, those skilled in the art will appreciate numerous modifications and variations therefrom. It is intended that the appended claims cover all such modifications and variations.

What is claimed is:

1. A method of generating a data log comprising:
receiving formation response signals with a nuclear magnetic resonance (NMR) tool;
processing the formation response signals to obtain a T1 distribution of nuclei of a mixture in the formation;
performing a blind source separation (BSS) independent component analysis (ICA) on the T1 distribution;
obtaining mixing data, comprising ratios of components of the mixture, from the BSS ICA; and
generating a data log comprising the mixing data.

2. The method of claim 1, wherein the T1 distribution is obtained without magnetic gradient information.

3. The method of claim 1, wherein generating the data log comprises identifying the ratios of components as a function of position along a borehole.

4. The method of claim 1, wherein performing the BSS ICA comprises identifying a component of the mixture from a spectral distribution curve.

5. The method of claim 4, wherein identifying the component comprises observing at least one feature of the spectral distribution curve that is correlative to the component.

6. The method of claim 5, wherein the at least one feature is correlative to hydrocarbons.

7. The method of claim 5, wherein the at least one feature is correlative to water.

8. The method of claim 1, wherein obtaining the T1 distribution comprises saturating the mixture with water and obtaining multiple T1 distributions over different saturation ratios.

9. The method of claim 1, further comprising displaying the mixing data.

10. A system for generating a subsurface data log comprising:
a nuclear magnetic resonance (NMR) tool that receives formation response signals;
a processor that:
processes the formation response signals to obtain a T1 distribution of nuclei of a mixture in the formation;
performs a blind source separation (BSS) independent component analysis (ICA) on the T1 distribution;
obtains mixing data, comprising ratios of components of the mixture, from the BSS ICA; and
generates a data log comprising the mixing data; and
memory that stores the data log.

11. The system of claim 10, wherein the NMR tool does not comprise a magnetic gradient sensor.

12. The system of claim 10, wherein the processor resides in the NMR tool.

13. The system of claim 10, wherein the processor resides in a data processing system on the surface of the formation.

14. The system of claim 10, further comprising a display that shows the mixing data.

15. The system of claim 14, wherein performing the BSS ICA causes the processor to output to the display a spectral distribution curve of one component of the mixture such that an interpreter may identify and input the component based on at least one feature of the spectral distribution curve that is correlative to the component.

16. The system of claim 15, wherein the at least one feature is correlative to hydrocarbons.

17. The system of claim 15, wherein the at least one feature is correlative to water.

18. The system of claim 10, wherein generating the data log causes the processor to identify the ratios of components as a function of position along a borehole.

19. The system of claim 18, further comprising a display that shows the ratios of components as a function of position along the borehole.

20. The system of claim 10, wherein obtaining the T1 distribution causes the processor to obtaining multiple T1 distributions over different saturation ratios.
